(19) United States
(12) Patent Application Publication
(10) Pub. No.: US 2025/0353422 A1
(43) Pub. Date: Nov. 20, 2025

(54) TELESCOPIC CYLINDER DUAL TRUNNION PORTS

(71) Applicant: K.T.I. HYDRAULICS, INC., TUSTIN, CA (US)

(72) Inventor: CHUN NIEN KING, IRVINE, CA (US)

(21) Appl. No.: 19/208,446

(22) Filed: May 14, 2025

Related U.S. Application Data
(60) Provisional application No. 63/648,618, filed on May 16, 2024.

(51) Int. Cl. B60P 1/16; B62D 27/02; B62D 63/08

(52) U.S. Cl. CPC B60P 1/16; B62D 27/023; B62D 63/08

(57) ABSTRACT

The present invention is an improvement mechanism and a method for a dump truck trailer to raise and lower the dump bed frame for easy disposal of material. The improvement mechanism comprises a cylinder mount frame, a telescopic cylinder and a cylinder top mount plate. The cylinder mount frame is attached to the trailer frame and the cylinder top mount plate is attached to the underside of the existing dump bed frame. The telescopic cylinder is attached to the cylinder mount frame by means of a trunnion mount and a plurality of fastening elements and to the cylinder top mount plate by means of the cylinder flush plate and the plurality of fastening elements.

### BACKGROUND OF THE DISCLOSURE

This application claims priority to and the benefit of provisional patent application No. 63/648,618 filed in the United States Patent Office on May 16, 2024.

### TECHNICAL FIELD OF THE DISCLOSURE

The present invention relates generally to dump truck trailers, and specifically to an improvement mechanism for a dump truck trailer with a bed frame capable of being moved to a raised and lowered positions.

### DESCRIPTION OF THE RELATED ART

Dump truck trailers are essential for the transportation of bulk materials, such as gravel, sand, and construction debris. Over time, the demand for more efficient, versatile, and durable dumping mechanisms has driven innovation in trailer design.

The primary function of a dump truck trailer is to unload its contents quickly and efficiently. Early dump trucks relied on manual or basic hydraulic lifting mechanisms to raise the bed frame of the trailer. These early designs were limited in their lifting capacity, ease of operation, and safety features. As industries expanded, so did the need for trailers with improved systems for tilting and dumping heavy loads in a controlled manner.

Early hydraulic dump mechanism for truck trailers, typically powered by hydraulic cylinders, allowed tilting of the bed frame for unloading. These systems were relatively simple, typically involving a basic piston or lever to raise the bed of the trailer. But such systems were often underpowered and could only lift relatively lighter loads and were less efficient, leading to slower lifting and lowering of the bed.

The advent of more advanced hydraulic systems marked a significant improvement. These systems allowed for smoother and more powerful movement of the dump bed, providing greater flexibility in the unloading process. This innovation set the stage for the development of bed frames that could be moved between raised and lowered positions with greater precision and reliability.

Some other hydraulic lift for dump truck beds had improved hydraulic system with multiple tilt positions. The introduction of more advanced hydraulic pumps and cylinders allowed for more efficient lifting and tilting. Some hydraulic system also included features for controlling the angle of tilt, giving operators better control of material unloading. However, the complexity of the system increased with the introduction of multi-position tilt controls, which could lead to more frequent mechanical issues and higher repair costs. The systems were still relatively heavy, which added to the overall weight of the trailer, reducing payload capacity.

Some conventional dump truck trailers focused on improving the mechanical lifting mechanisms, utilizing hydraulic pistons, cylinders, and other components to control the bed's angle and height during operation. As the technology matured, new designs began to address the issues of stability, safety, and ease of use. For example, some prior arts focused on mechanisms that could raise the bed at different angles, allowing for the discharge of materials in various conditions and types of terrain. Others provided reinforced frames and stabilizers to improve safety and prevent tipping during operation and aimed to provide a more robust and efficient hydraulic system that could lift heavier loads with less wear and tear on the trailer components. However, reinforced frames and added stabilizers resulted in an increase in the trailer's overall weight, which could negatively impact fuel efficiency and the vehicle's payload capacity. Moreover, advanced safety features, made the system more complex, and failure of safety controls could lead to catastrophic accidents. The complexity of systems also made routine maintenance costlier and required specialized knowledge for repairs.

Therefore, there is a need for an improvement mechanism and a method for a trailer truck that would allow raising and lowering of the bed frame easily. Such an improvement mechanism would allow lifting of heavier loads efficiently. Such an improvement mechanism would be simple in construction and allow maximum tilting of the bed frame to unload all the material from the bed frame. Such an improvement mechanism would eliminate the need for the hoist mechanism which makes the bed frame relatively light weight with less mechanical issues and less repair costs. The design of the improvement mechanism reduced the overall weight and increased the payload capacity. The present embodiment overcomes prior art shortcomings by accomplishing these critical objectives.

### SUMMARY OF THE DISCLOSURE

To minimize the limitations found in the prior art, and to minimize other limitations that will be apparent upon the reading of the specification, the present invention provides an improvement mechanism for a dump truck trailer to raise and lower the dump bed frame for easy disposal of material and a method for making the improvement mechanism.

The improvement mechanism for a dump truck trailer comprises a cylinder mount frame, a telescopic cylinder and a cylinder top mount plate. The cylinder mount frame is attached to the trailer frame. The cylinder mount frame includes a pair of vertical members each having a first end and a second end, an elongated horizontal member and a short horizontal member. The elongated horizontal member is attached to the pair of vertical members at the first end and the short horizontal member is attached to the second end of the pair of vertical members. The pair of vertical members is configured such that it touches the cross member of the trailer frame being cut, when the cylinder mount frame is positioned in the space formed by cutting the cross member. The cylinder mount frame is attached to the trailer frame by welding the elongated horizontal member and the short horizontal member to the trailer.

The telescopic cylinder is attached to the cylinder mount frame by means of a trunnion mount and a plurality of fastening means. The telescopic cylinder includes a pair of ports and a cylinder flush plate having a plurality of holes.

The cylinder top mount plate is attached to the underside of the existing dump bed frame. The cylinder top mount plate includes a bottom face having a plurality of mount studs. The plurality of mount studs can be welded studs or threaded studs. The telescopic cylinder is attached to the cylinder top mount plate by means of the cylinder flush plate and the plurality of fastening means. The telescopic cylinder is positioned under the cylinder top mount plate such that the plurality of mount studs on the cylinder top mount plate passes through the plurality of holes in the cylinder flush plate and the plurality of fastening means is utilized to secure the telescopic cylinder to the cylinder mount plate.

The method for making the improvement mechanism for the dump truck trailer, comprises the steps of, removing the dump bed frame from the trailer frame of the existing dump truck trailer. Then, trimming the cross member of the trailer frame. Attaching a cylinder mount frame to the trailer frame through the space formed by trimming the cross member of the trailer frame by welding. Then, attaching a telescopic cylinder having a pair of ports to the cylinder mount frame by means of a trunnion mount and a plurality of fastening means and after that attaching a cylinder top mount plate onto the underside of the existing dump bed frame. Finally, attaching the telescopic cylinder to the cylinder top mount plated by means of a cylinder flush plate on the telescopic cylinder.

A first objective of the present invention is to provide an improvement mechanism and a method for a trailer truck that would allow raising and lowering of the bed frame easily.

A second objective of the present invention is to provide an improvement mechanism that allows lifting of heavier loads efficiently.

Another objective of the present invention is to provide an improvement mechanism that is simple in construction and allow maximum tilting of the bed frame to unload all the material from the bed frame.

Another objective of the present invention is to provide an improvement mechanism that eliminates the need for the hoist mechanism which makes the bed frame relatively light weight with less mechanical issues and less repair costs.

Another objective of the present invention is to provide an improvement mechanism that has a reduced overall weight and increased the payload capacity.

These and other advantages and features of the present invention are described with specificity so as to make the present invention understandable to one of ordinary skill in the art.

### BRIEF DESCRIPTION OF THE DRAWINGS

In order to enhance their clarity and improve understanding of these various elements and embodiments of the invention, elements in the figures have not necessarily been drawn to scale. Furthermore, elements that are known to be common and well understood to those in the industry are not depicted in order to provide a clear view of the various embodiments of the invention, thus the drawings are generalized in form in the interest of clarity and conciseness.

FIG. 1 shows a perspective view of an improvement mechanism incorporated in an existing dump truck trailer in accordance with the preferred embodiment of the present invention;

FIG. 2 illustrates a perspective view of the trailer frame with a cross member being trimmed in accordance with the preferred embodiment of the present invention;

FIG. 3 illustrates a perspective view of a cylinder mount frame attached to the trailer frame in accordance with the preferred embodiment of the present invention;

FIG. 4 illustrates a top perspective view of a telescopic cylinder attached to the cylinder mount frame in accordance with the preferred embodiment of the present invention;

FIG. 5 illustrates a top perspective view of a cylinder top mount plate attached to the dump bed frame in accordance with the preferred embodiment of the present invention;

FIG. 6A illustrates a bottom perspective view of the cylinder top mount plate attached to the dump bed frame in accordance with the preferred embodiment of the present invention;

FIG. 6B illustrates a bottom perspective view of the telescopic cylinder positioned under the cylinder top mount plate attached to the dump bed frame in accordance with the preferred embodiment of the present invention;

FIG. 6C illustrates a bottom perspective view of the telescopic cylinder attached to the cylinder top mount plate in accordance with the preferred embodiment of the present invention;

FIG. 7 illustrates a bottom perspective view of the telescopic cylinder attached to the cylinder top mount plate connected to the dump bed frame in accordance with the preferred embodiment of the present invention;

FIG. 8 illustrates a top perspective view of the cylinder mount frame attached to the trailer frame and the cylinder top mount plate connected to the dump bed frame without the telescopic cylinder in accordance with the preferred embodiment of the present invention;

FIG. 9 illustrates the dump bed frame of the dump truck trailer in a raised position utilizing the improvement mechanism having the telescopic cylinder in accordance with the preferred embodiment of the present invention;

FIG. 10A illustrates a perspective view of the telescopic cylinder in accordance with the preferred embodiment of the present invention;

FIG. 10B illustrates a cross-sectional view of the telescopic cylinder in accordance with the preferred embodiment of the present invention; and

FIG. 11 illustrates a flowchart of a method of making an improvement mechanism for the dump truck trailer in accordance with the preferred embodiment of the present invention.

### DETAILED DESCRIPTION OF THE PREFERRED EMBODIMENT

In the following discussion that addresses several embodiments and applications of the present invention, reference is made to the accompanying drawings that form a part hereof, and in which is shown by way of illustrating specific embodiments in which the invention may be practiced. It is to be understood that other embodiments may be utilized and changes may be made without departing from the scope of the present invention. Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. The invention will now be described with reference to the accompanying drawings which do not limit the scope of the invention. In the following discussion that addresses a number of embodiments and applications of the present invention, reference is made to the accompanying drawings that form a part hereof, and in which is shown by way of illustrating specific embodiments in which the invention may be practiced. It is to be understood that other embodiments may be utilized and changes may be made without departing from the scope of the present invention.

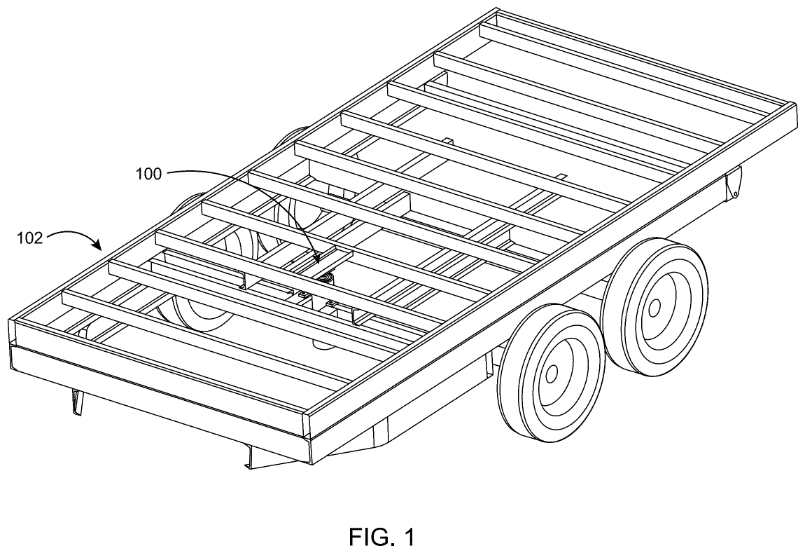

FIG. 1 shows a perspective view of an improvement mechanism 100 incorporated in an existing dump truck trailer in accordance with the preferred embodiment of the present invention. The improvement mechanism 100 of the present application allows to raise the dump truck from a lowered position. This mechanism 100 eliminates the need of the conventional hoisting mechanism utilized in the existing dump trucks.

The improvement mechanism 100 for a dump truck trailer, comprises a cylinder mount frame 104, a telescopic cylinder 106 and a cylinder top mount plate 108. The cylinder mount frame 104 is attached to the trailer frame 110 of the existing dump truck trailer. The cylinder top mount plate 108 is attached to the underside of the existing dump bed frame 112. The telescopic cylinder 106 is attached to the cylinder mount frame 104 and to the cylinder top mount plate 108 by means of the cylinder flush plate and the plurality of fastening means. The telescopic cylinder 106 utilized in the improved mechanism 100 allows to raise and lower the dump bed frame 112 for easy disposal of material from the dump truck trailer.

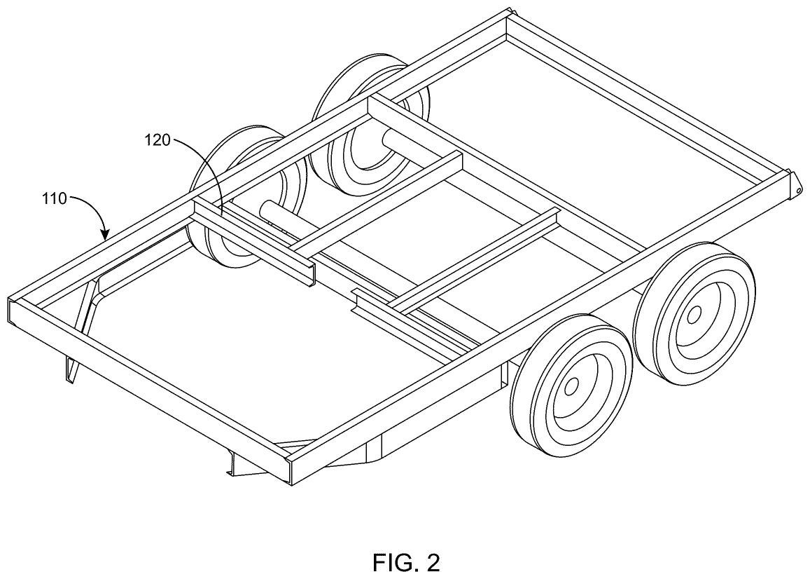

FIG. 2 illustrates a perspective view of the trailer frame 110 with a cross member 120 being trimmed in accordance with the preferred embodiment of the present invention. The cross member 120 is trimmed to accommodate the improvement mechanism of the present invention.

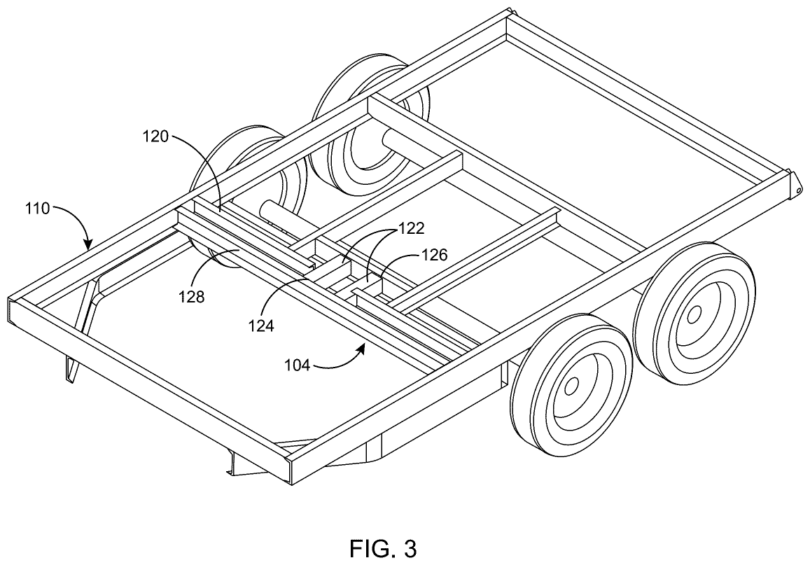

FIG. 3 illustrates a perspective view of the cylinder mount frame 104 attached to the trailer frame 110. The cross member 120 of the trailer frame 110 is being cut, as illustrated in FIG. 2, to provide sufficient space to accommodate the cylinder mount frame 104. The cylinder mount frame 104 is then attached to the trailer frame 110 by means of a trunnion mount 114 and a plurality of fastening means 116. The cylinder mount frame 104 includes a pair of vertical members 122 each having a first end 124 and a second end 126, an elongated horizontal member 128 and a short horizontal member 130. The elongated horizontal member is attached to the pair of vertical members at the first end and the short horizontal member 128 is attached to the second end 126 of the pair of vertical members 122. The pair of vertical members 122 is configured such that it touches the cross member 120 of the trailer frame 110 being cut, when the cylinder mount frame 104 is positioned in the space formed by cutting the cross member 120. The cylinder mount frame 104 is attached to the trailer frame 110 by welding the elongated horizontal member 128 and the short horizontal member 130 to the trailer.

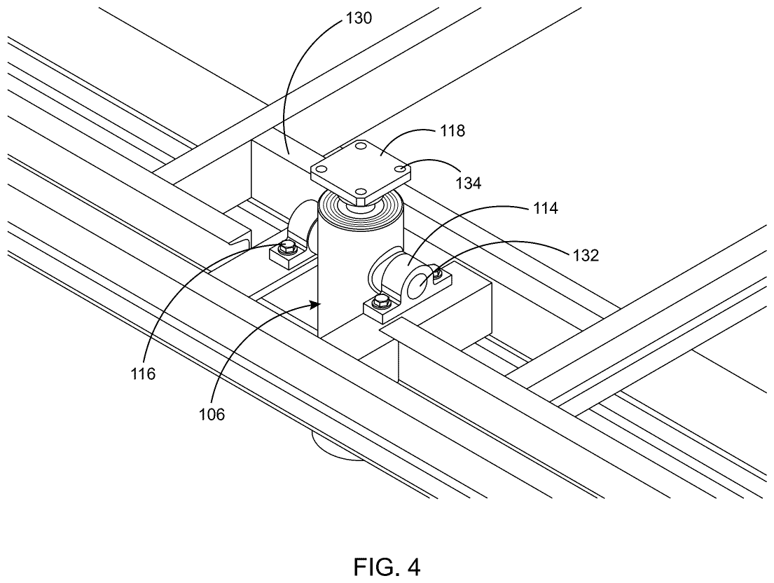

FIG. 4 illustrates a top perspective view of the telescopic cylinder 106 attached to the cylinder mount frame 104 in accordance with the preferred embodiment of the present invention. The telescopic cylinder 106 includes a pair of ports 132 and a cylinder flush plate 118 having a plurality of holes 134. Each of the plurality of fastening means 116 can, preferably include, a zinc plated hex head cap screw, hardened flat washers and a nylon lock nut. At the resting position, the telescopic cylinder 106 is retracted.

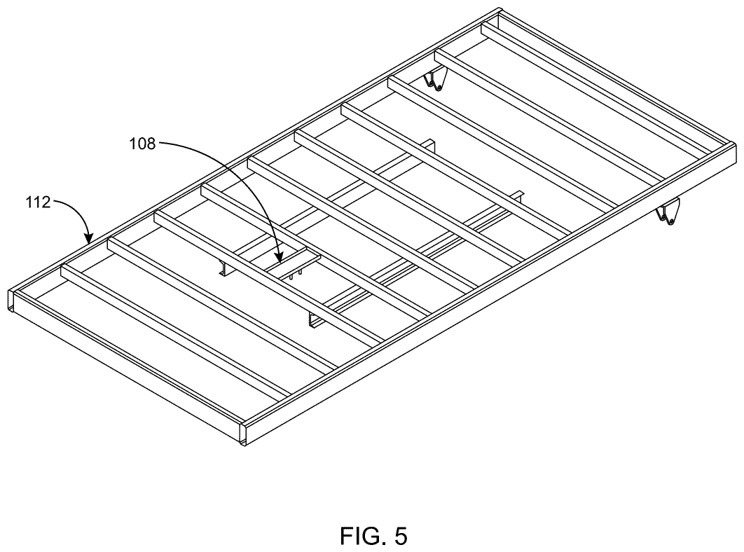

FIG. 5 illustrates a top perspective view of the cylinder top mount plate 108 attached to the dump bed frame 112. The cylinder top mount plate 108 includes a bottom face having a plurality of mount studs 138. The plurality of mount studs 138 can be welded studs or threaded studs.

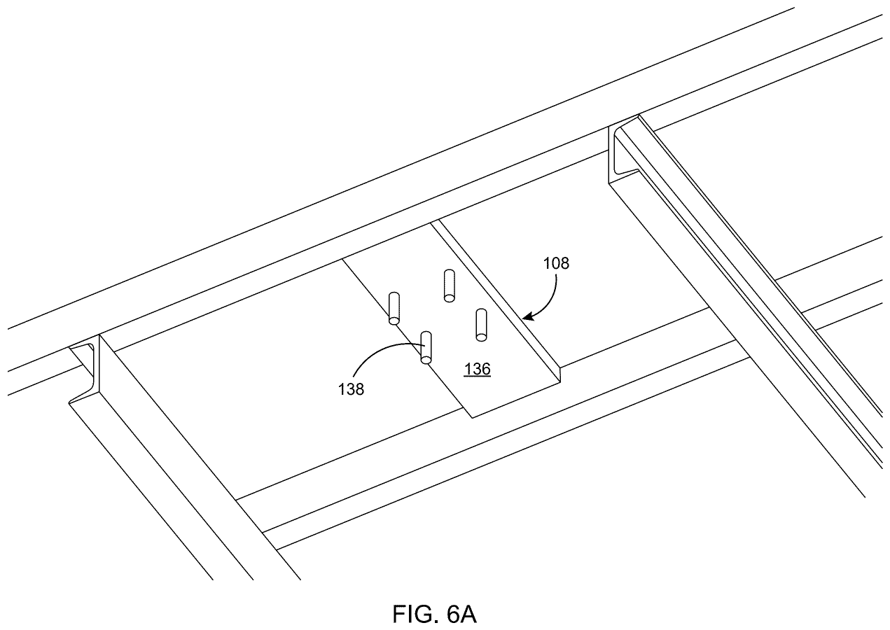

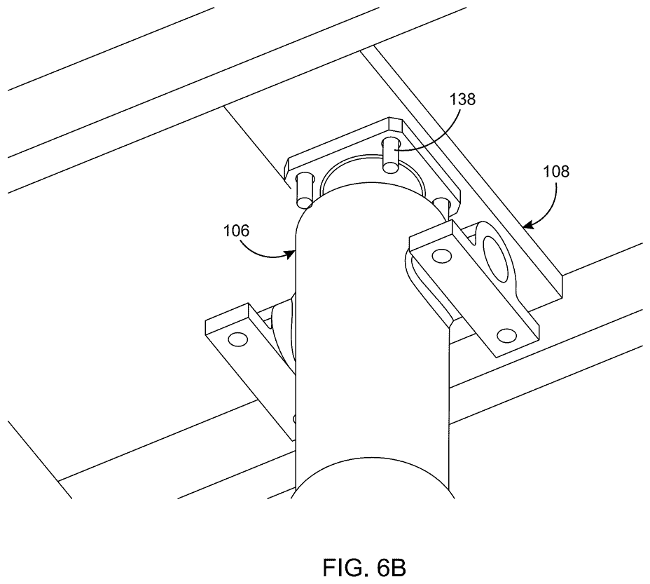

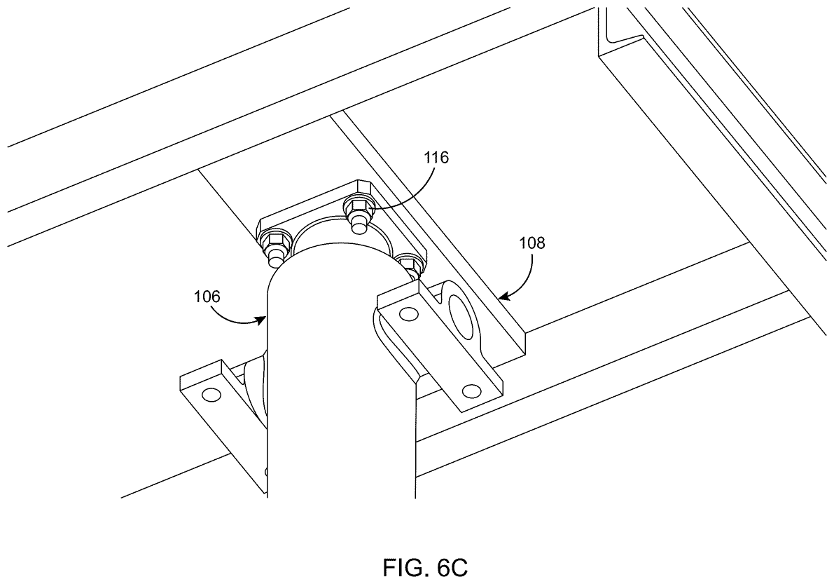

FIGS. 6A-6C illustrate attaching the telescopic cylinder 106 to the cylinder mount plate 108. The cylinder top mount plate 108 is centered and attached over the telescopic cylinder 106 through the cylinder flush plate 118. In FIG. 6A, a bottom perspective view of the cylinder top mount plate 108 attached to the dump bed frame 112 is shown, illustrating the plurality of mount studs 138 for attaching the telescopic cylinder 106. The telescopic cylinder 106 is positioned under the cylinder top mount plate 108 such that the plurality of mount studs 138 on the cylinder top mount plate 108 passes through the plurality of holes 134 in the cylinder flush plate 118, as illustrated in FIG. 6B. The plurality of fastening means 116 is utilized to secure the telescopic cylinder 106 to the cylinder top mount plate 108, as illustrated in FIG. 6C.

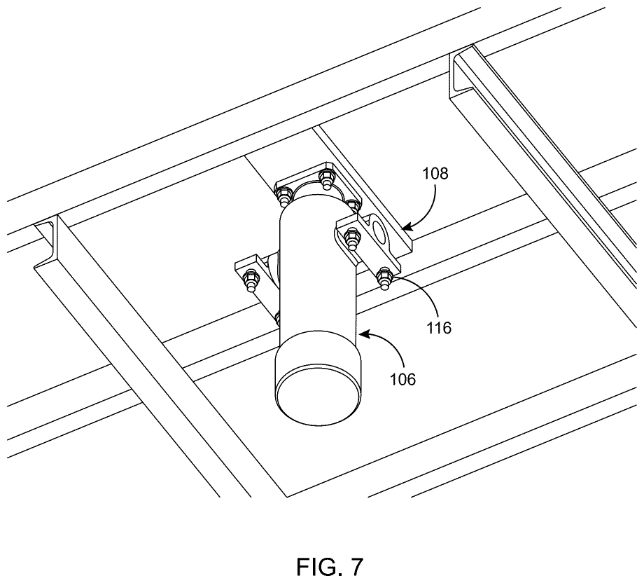

FIG. 7 illustrates a bottom perspective view of the telescopic cylinder 106 attached to the cylinder top mount plate 108 connected to the dump bed frame 112. In FIG. 7, the telescopic cylinder 106 is not attached to the cylinder mount frame 104.

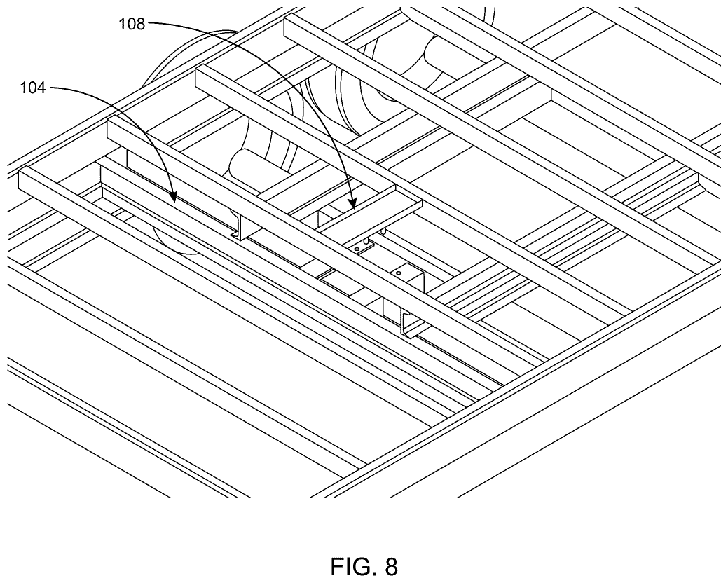

FIG. 8 illustrates a top perspective view of the cylinder mount frame 104 attached to the trailer frame 110 and the cylinder top mount plate 108 connected to the dump bed frame 112 without the telescopic cylinder 106. The cylinder mount frame 104 allows the bed frame 112 to ride on the trailer frame 110 instead of the telescopic cylinder 106 during transit.

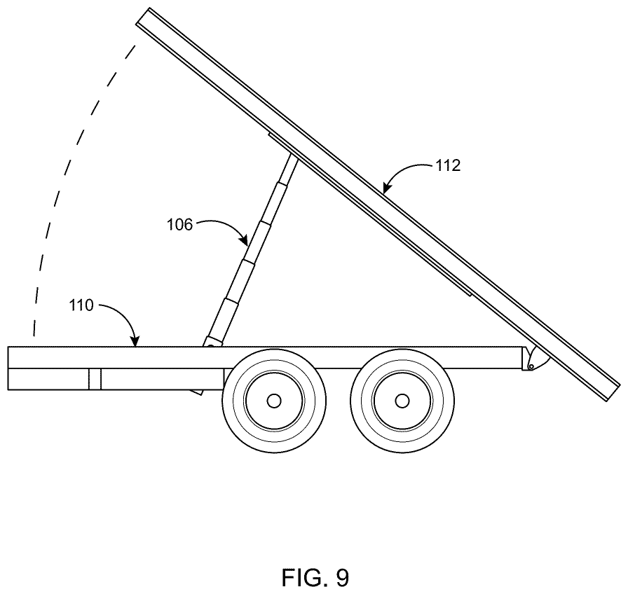

FIG. 9 illustrates the dump bed frame 112 of the dump truck trailer in a raised position utilizing the improvement mechanism 100 having the telescopic cylinder 106. The telescopic cylinder 106 is operated by a single ended hydraulic power unit (HPU) delivering 2000 PSI at 2GPM. When the telescopic cylinder 106 is extended, the dump bed frame 112 will tilt at an angle that allows for the contents to be discharged from the dump bed.

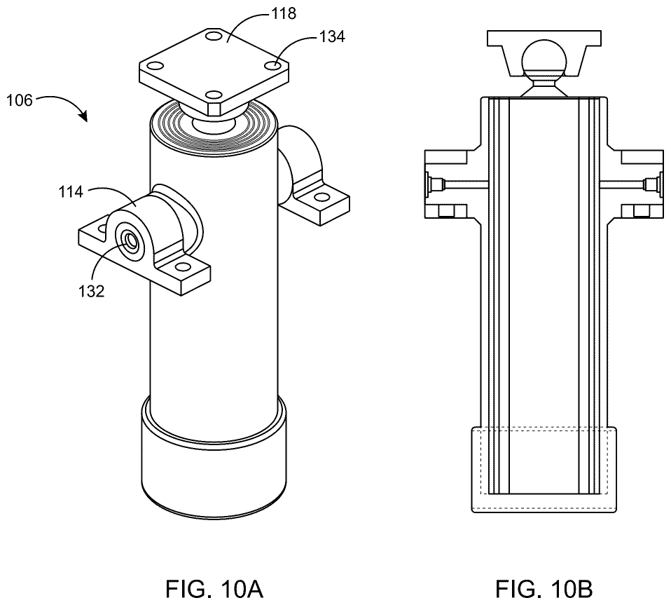

FIG. 10A illustrates a perspective view of the telescopic cylinder 106 and FIG. 10B illustrates a cross-sectional view of the telescopic cylinder 106 in accordance with the preferred embodiment of the present invention. The use of the telescopic cylinder 106 in an underbody mount like the cylinder mount frame 104 in a dump trailer is unique. Further, additional fill/lower port (not shown) is added to the trunnions 114. The telescopic cylinder is set up with dual ports 132 on the end face of the trunnion mount 114. In the event a user would like to utilize this port for quicker extension with a dual hydraulic pump source, the plug can be removed and an additional hose connected to the hydraulic pump.

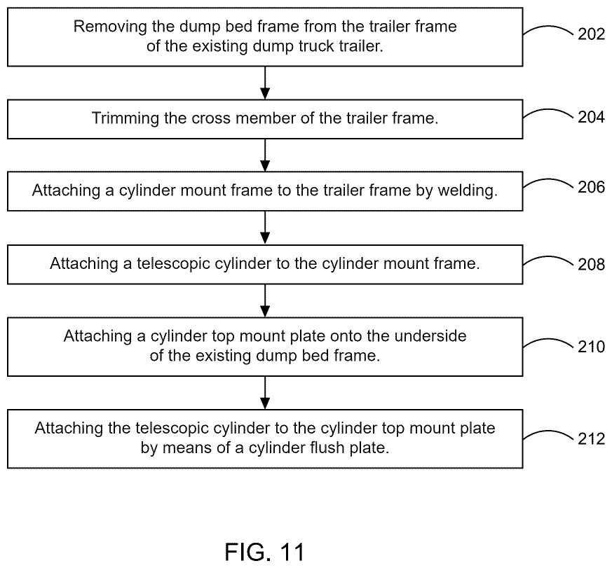

FIG. 11 illustrates a flowchart of a method for making the improvement mechanism for the dump truck trailer. The method comprising the steps of, removing the dump bed frame from the trailer frame of the existing dump truck trailer, as indicated in block 202. Then, trimming the cross member of the trailer frame, as indicated in block 204. As indicated in block 206, attaching a cylinder mount frame to the trailer frame by welding wherein the cylinder mount frame includes a pair of vertical members each having a first end and a second end, the pair of vertical members is attached to an elongated horizontal member at the first end and a short horizontal member is attached to the second end. The cylinder mount frame is attached to a space formed by trimming the cross member of the trailer frame. Then, attaching a telescopic cylinder having a pair of ports to the cylinder mount frame by means of a trunnion mount and a plurality of fastening means, as indicated in block 208 and after that attaching a cylinder top mount plate onto the underside of the existing dump bed frame, as indicated in block 210. Finally, attaching the telescopic cylinder to the cylinder top mount plated by means of a cylinder flush plate on the telescopic cylinder, as indicated in block 212.

The improvement mechanism 100 for the trailer truck allows raising and lowering of the dump bed frame 112 easily. The present invention allows lifting of heavier loads efficiently. The improvement mechanism 100 for the trailer truck is simple in construction and allows maximum tilting of the dump bed frame 112 to unload all the material from the bed frame 112. By employing the improvement mechanism 100 of the present invention, the need for the hoist mechanism is eliminated, which makes the bed frame 112 relatively light weight. The improvement mechanism 100 can also be utilized with multiple hydraulic pump source for quicker extension, removing the plug/s and connecting an additional hose from the hydraulic pump to the cylinder's extra ports. The design of the improvement mechanism 100 reduces the overall weight, increase the payload capacity with less mechanical issues and less repair costs.

The claimed subject matter has been provided here with reference to one or more features or embodiments. Those skilled in the art will recognize and appreciate that, despite the detailed nature of the exemplary embodiments provided here, changes and modifications may be applied to said embodiments without limiting or departing from the generally intended scope. These and various other adaptations and combinations of the embodiments provided here are within the scope of the disclosed subject matter as defined by the claims and their full set of equivalents.

The foregoing description of the preferred embodiment of the present invention has been presented for the purpose of illustration and description. It is not intended to be exhaustive or to limit the invention to the precise form disclosed. Many modifications and variations are possible in the froth generating system of the above teachings. It is intended that the scope of the present invention not be limited by this detailed description, but by the claims and the equivalents to the claims appended hereto.

What is claimed is:

1. An improvement mechanism for a dump truck trailer, comprising:
a cylinder mount frame attached to a cross member of an existing trailer frame, the cross member of the trailer frame being cut to allow sufficient space to attach the cylinder mount frame;
a telescopic cylinder includes a cylinder flush plate and a pair of ports, the telescopic cylinder attached to the cylinder mount frame by means of a trunnion mount and a plurality of fastening means; and
a cylinder top mount plate attached to the underside of the existing dump bed frame, the telescopic cylinder attached to the cylinder top mount plate by means of the cylinder flush plate and the plurality of fastening means;
wherein the telescopic cylinder allows to raise and lower the dump bed frame for easy disposal of material from the dump truck trailer.

2. The improvement mechanism of claim 1 wherein the cylinder mount frame includes a pair of vertical members each having a first end and a second end, the pair of vertical members is attached to an elongated horizontal member at the first end and a short horizontal member is attached to the second end.

3. The improvement mechanism of claim 2 wherein the pair of vertical members is configured such that it touches the cross member of the trailer frame being cut.

4. The improvement mechanism of claim 2 wherein the elongated horizontal member and the short horizontal member is attached to the trailer frame by welding.

5. The improvement mechanism of claim 1 wherein the telescopic cylinder mounted to a center position of the dump bed frame for raising and lowering the dump bed frame.

6. The improvement mechanism of claim 1 wherein the telescopic cylinder is attached to the underside of the cylinder mount frame.

7. The improvement mechanism of claim 1 wherein the cylinder mount frame is attached to the cross member of the existing trailer frame by welding.

8. The improvement mechanism of claim 1 wherein the cylinder mount frame allows the bed frame to ride on the trailer frame instead of the telescopic cylinder during transit.

9. A method of making an improvement mechanism for a dump truck trailer, the method comprising the steps of:
a) removing the dump bed frame from the trailer frame of the existing dump truck trailer;
b) trimming the cross member of the trailer frame;
c) attaching a cylinder mount frame to the trailer frame by welding, the cylinder mount frame includes a pair of vertical members each having a first end and a second end, the pair of vertical members is attached to an elongated horizontal member at the first end and a short horizontal member is attached to the second end;
d) attaching a telescopic cylinder having dual ports onto the cylinder mount frame;
e) attaching a cylinder top mount plate onto the underside of the existing dump bed frame; and
f) attaching the telescopic cylinder to the cylinder top mount plated by means of a cylinder flush plate on the telescopic cylinder.

10. The method of claim 9 wherein a pair of vertical members of the cylinder mount frame is attached to a space formed by trimming the cross member of the trailer frame.

11. The method of claim 9 wherein the ends of an elongated horizontal member and a short horizontal member of the cylinder mount frame is attached to the trailer frame.

12. The method of claim 9 wherein the telescopic cylinder having a pair of ports is attached to the cylinder mount frame by means of a trunnion mount.

13. A method of making an improved dump truck trailer, the method comprising the steps of:
a) removing the dump bed frame from the trailer frame of the existing dump truck trailer;
b) trimming the cross member of the trailer frame;
c) attaching a cylinder mount frame to the trailer frame by welding such that a pair of vertical members of the cylinder mount frame touches the trimmed cross member of the trailer frame and the ends of an elongated horizontal member and a short horizontal member of the cylinder mount frame is attached the trailer frame;
d) attaching a telescopic cylinder having dual ports by means of a trunnion mount onto the cylinder mount frame;
e) attaching a cylinder top mount plate onto the underside of the existing dump bed frame; and
f) attaching the telescopic cylinder to the cylinder top mount plated by means of a cylinder flush plate on the telescopic cylinder.
